(19) United States
(12) Patent Application Publication
(10) Pub. No.: US 2011/0011310 A1
(43) Pub. Date: Jan. 20, 2011

(54) METHOD OF MANUFACTURING A COMPOSITE BASED ON COMPLEXES OF CONTROLLED STABILITY

(75) Inventors: Anne-Marie Chaze, Nice (FR); Francoise Giulieri, Nice (FR); Sonia Ovarlez, Chatillon (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: UNIVERSITE DE NICE SOPHIA-ANTIPOLIS, Nice (FR)

(21) Appl. No.: 12/808,892

(22) PCT Filed: Dec. 17, 2008
(86) PCT No.: PCT/FR2008/001760

§ 371 Date: Sep. 9, 2010

(30) Foreign Application Priority Data
Dec. 17, 2007 (FR) 0708777

(51) Int. Cl. C09C 1/02

(52) U.S. Cl. 106/468

(57) ABSTRACT

The method for manufacturing a composite based on complexes of controlled stability over time using a fibrous inorganic matrix having tunnels and one or more organic compounds incorporated into said tunnels includes the following steps: the fibrous inorganic matrix having tunnels and the organic compound or compounds are provided; the fibrous inorganic matrix having tunnels is mixed with the organic compound or compounds so that said organic compound or compounds are incorporated into the tunnels of the fibrous inorganic matrix; the retention of the organic compound or compounds in said tunnels and their release therefrom by heating said mixture obtained, at a chosen temperature for a defined time, are controlled. The invention applies in particular in a preparation intended for cosmetic, pharmacological, nutri-therapeutic and agri-foodstuff, phytosanitary, petroleum or electronic usage or else in paints.

This invention relates to a method for producing a composite based on complexes of controlled stability, including, on the one hand, an inorganic fibrous matrix with tunnels, and, on the other hand, one or more organic compounds incorporated into said tunnels. It also relates to various uses of such a composite, in particular in the fields of cosmetics, pharmacology, nutritional therapy and agrifood, in the phytosanitary field as well as in the fields of petroleum, electronics and paint.

In the literature, the presence of small organic polar molecules such as pyridine (W. Kuang et al., Chem. Mater. 15, 4956-4967, 2003), amino pyridine (S. Akyüz et al., J. Molecular Structure 565-566, 487-491, 2001), acetone (W. Kuang et al., J. Mater. Chem. 16, 179-185, 2006), incorporated in tunnels of a fibrous inorganic matrix, was clearly demonstrated.

However, the incorporation of larger molecules in the tunnels of such a fibrous inorganic matrix currently remain very controversial.

Indeed, even if digital simulations, tests and new properties have enabled it to be assumed that an indigo molecule, for example, as an organic compound, could be incorporated into an attapulgite- or sepiolite-type clay with tunnels (Maya Blue) (G. Chiari et al., Eur. J. Mineral. 15, 21-33, 2003, E. Fois et al., Elsevier Sc. 57, 167-174, 2003), no direct proof has demonstrated the actual presence of a molecule of this size in clays with tunnels. Instead, structural studies, in particular NMR, have demonstrated very minor interactions between indigo and the inner surface of sepiolite, suggesting that the molecules cannot in fact penetrate the tunnels (B. Hubbard et al., Clays and Clay Minerals 51, 318-326, 2003).

In addition, scientists Van Olphen and Littmann have studied and published information on the reproduction of Maya Blue, an organic/inorganic complex in which the inorganic matrix with tunnels is attapulgite and the organic compound is indigo (Edwin R. Littmann, “Maya Blue. Further Perspectives and the Possible Use of Indigo as the Colorant” American Antiquity, vol. 47, no. 2 (April 1982), pages 404-408). These authors indeed wanted to understand the techniques previously used by the Mayas to produce Maya Blue. According to Edwin R. Littmann, Maya Blue could result from heating, at the boiling temperature of water for a relatively long time, a mixture of attapulgite and leaves and stems of the indigo plant. It appears that, according to Van Olphen, such complexes could similarly be obtained at a heating temperature of 190° C.

Such complexes are also disclosed in the patent published under number U.S. Pat. No. 7,052,541. This patent indeed describes compositions based on complexes comprised of organic pigments derived from indigo and a fibrous or platy clay. These compositions enable a wide variety of colors to be obtained by varying in particular certain synthesis conditions.

However, according to the applicant, and contrary to what is suggested by the aforementioned prior art document, it appears that the complexes thus prepared are not stable over time. The prior art never teaches how to obtain a composite based on organic/inorganic complexes of which the stability over time can be controlled.

In addition, and in consideration of the above, a problem to be solved by the invention is that of providing a method for producing a composite based on complexes including an inorganic fibrous matrix with tunnels, and one or more organic compounds incorporated in said tunnels, which has controlled stability over time.

The solution provided by the invention to this problem is thus first a method for producing a composite based on complexes of controlled stability over time including, on the one hand, an inorganic fibrous matrix with tunnels, and, on the other hand, one or more organic compounds incorporated into said tunnels, characterized in that it comprises the following steps, in which:

the inorganic fibrous matrix with tunnels and the organic compound(s) are provided;

the inorganic fibrous matrix with tunnels and the organic compound(s) are mixed so that said organic compound(s) are incorporated into the tunnels of the inorganic fibrous matrix; and

the maintenance of the organic compound(s) in said tunnels, and the release thereof, heating said mixture obtained at a chosen temperature for a determined time, is controlled.

The applicant has provided a method comprising a step of controlling the maintenance of the organic compound(s) in the tunnels and the release thereof over time. This control of the maintenance/release of the organic compounds is thus ensured by an adjustment of two parameters: the temperature of heating of the complex and the heating time, in which adequate mixing must however be performed so that, prior to the heating step, the organic molecules are incorporated into the tunnels of the inorganic fibrous matrix. Finally, the method according to the invention enables a composite to be obtained that is based on complexes of which the stability is controlled over time and can be chosen as needed. The complex is more stable when the organic compound remains in place for a longer time in the tunnels of the matrix, and it is less stable when the organic compound remains for a shorter time and is therefore released more quickly into the external medium. In particular, a composite based on complexes is stable when the incorporation of the organic compound in the tunnels tends to be irreversible, and a composite based on complexes is unstable when this incorporation is reversible.

The method for producing the composite based on complexes according to the invention has, in particular, the following advantages:
it enables stable pigments with varied colors and tonalities and having a particular brightness to be developed. The pigments have the properties of inorganic pigments while being developed from synthetic organic compounds or extracted from natural products;
it enables the development of composites based on complexes of which the organic compounds incorporated into the tunnels have olfactory or biologically active properties;
it prevents the reversible and irreversible breakdown of the inorganic fibrous matrix at its usual temperature owing to the incorporation of organic compounds;
it enables the control over time of the stability of the composite based on complexes by heating the mixture obtained at a chosen temperature for a determined time;
the mixture obtained can be heated at a temperature above the temperature of decomposition of the organic compound(s) without altering the physicochemical properties thereof;
it enables protection of the organic compound(s) from external stresses such as acidic or basic media, UV, etc., by stabilizing them in the tunnels of the inorganic fibrous matrix;
it enables different organic compounds to cohabitate in the tunnels of the inorganic fibrous matrix;
it enables fibers filled with different organic compounds to cohabitate in the same external medium while preventing any contact and any reaction between said compounds;
it enables the release of the organic compound(s) in the external dispersion medium to be controlled;
it enables different organic compounds to be reacted in a controlled manner only after the release thereof in the external dispersion medium; and
the method for producing the composite based on complexes is non-toxic, and no solvent is required.

Advantageously:—the inorganic fibrous matrix and the organic compound(s) are mixed by grinding;—the grinding time is between 0 and 72 hours, preferably between 1 minute and 1 hour;—the mixture is heated for between 0 and 120 hours, preferably between 1 minute and 1 hour, at a temperature of between 18 and 950° C.;—the maintenance of the organic compound(s) is controlled by heating the mixture for between 1 minute and 1 hour, at a temperature above 300° C.;—the mixture is heated at a temperature above or equal to the temperature of decomposition of the organic compound;—the inorganic fibrous matrix with tunnels is a clay;—the clay is a clay of the palygorskite family;—the clay is a sepiolite;—the organic compound(s) are a natural or synthetic dye molecule, a flavored gustatory or olfactory molecule, or an active molecule, taken alone or in combination;—the synthetic or natural dye molecule is chosen from the indigoids, the anthraquinones, the flavonoids, the azoids, the melanins, the tetrapyrroles, the nitro dyes, the nitroso dyes, the polymethine dyes, the diphenylmethane dyes, and the triphenylmethane dyes;—the flavored gustatory or olfactory molecule is chosen from the floral families, chypres, ferns, leathers, woods, orientals, hesperidins, musks, and spices;—the active molecule is chosen from the alcohols, esters, ethers, carbonyl derivatives, ketone derivatives, thiols, sulfur derivatives (mercaptans), nitrogen derivatives, phenols, polyphenols, alkaloids, carbohydrates, ureas, sulfonylureas, ethylenes, vitamins, amines, amino acids, acethylenes, acrylates, steroids and lipids;—the composite based on complexes includes between 0.05 and 30% organic compound by weight of the total weight of said composite;—the composite based on complexes includes between 0.5 and 15% organic compound by weight of the total weight of said composite;—two of the dimensions of the organic compound are less than or equal to 11 Å and 5.7 Å, and the third dimension is not limited, or said organic compound is capable of conforming to such dimensions;—the method comprises at least one step of annealing the mixture of the inorganic fibrous matrix with tunnels and the organic compound(s) preferably performed after cooling of said mixture, after the initial heating step;—the annealing temperature is higher than the temperature chosen for the initial heating step;—the annealing temperature is higher than the temperature of decomposition of the organic compound;—the duration of the annealing step is shorter than that of the initial heating step;—the method also comprises a step of controlling the pH; and—the method comprises an ultrasonication of the inorganic fibrous matrix.

In addition, the solution of the invention has as ulterior objectives the use of a composite based on complexes of controlled stability developed according to the method of the invention, in a preparation intended for use in cosmetics, pharmacology, nutritional therapy, agrofood, phytosanitation, petroleum, electronics or in paints.

Advantageously:—the preparation is intended for make-up and/or care product chemistry, hair coloring or a perfume or odorizing composition;—the preparation is intended to be administered orally or topically and intended to release the active organic compound(s) into the human body;—the preparation is integrated in implants;—the preparation is intended for incorporating nutrients and/or flavoring agents, food additives and preservatives;—the preparation is intended for incorporating pesticides;—the preparation is used for pollution removal from soil and water;—the preparation is used in petroleum refining processes;—the preparation is used in electrical cables;—the preparation is used to improve electrical and thermal insulation of cables, and to detect short circuits;—the preparation is intended for industrial or artists' paints, or for coloring concrete, cement, lime plaster, wood, elastomers or plastic materials;—and the preparation is intended to combine the reinforcement/coloring properties for elastomers or polymers.

The invention also relates to a composition including a composite based on complexes including, on the one hand, an inorganic fibrous matrix with tunnels, and, on the other hand, one or more organic compounds incorporated into said tunnels, in which the composite preferably has controlled stability over time and is preferably prepared according to the production method according to the invention. Preferably, the organic compound(s) are a flavored gustatory or olfactory molecule, or an active molecule, taken alone or in combination. Preferably, the composition is pharmaceutical or dermatological and the organic compound(s) are an active molecule.

The invention can be better understood in view of the following non-limiting description, with reference to the appended figures, in which:

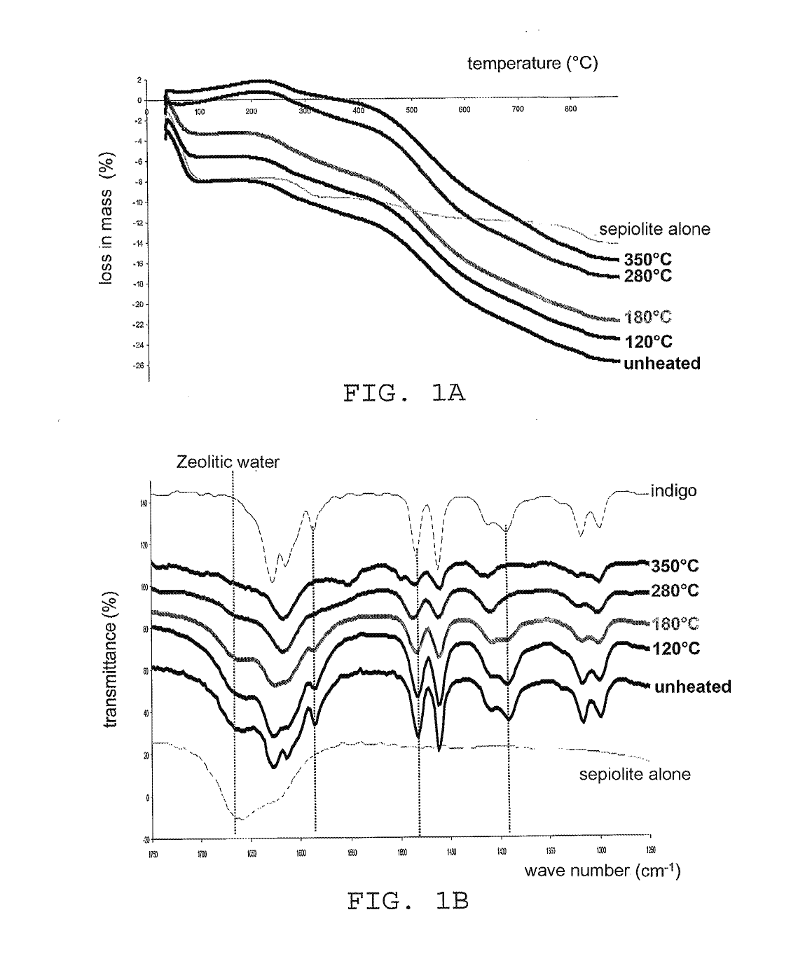

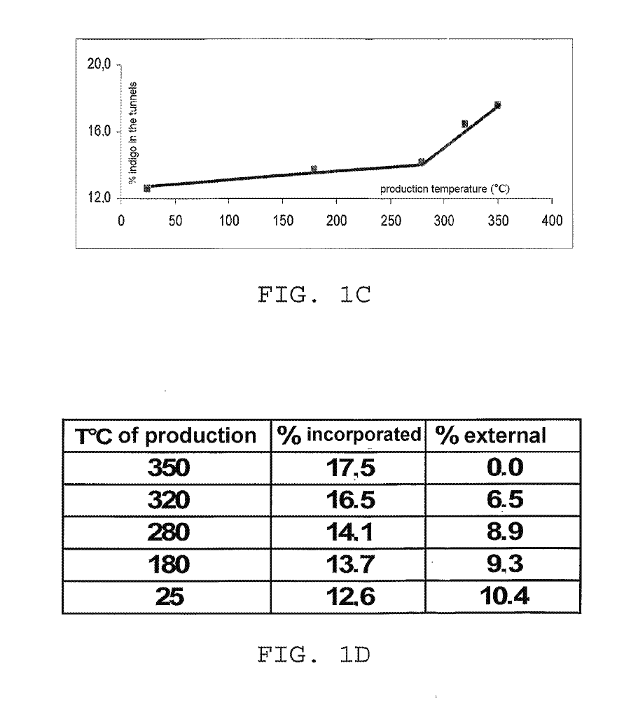

FIG. 1A shows the measurement by thermogravimetry of the incorporation of indigo in the sepiolite tunnels, for an indigo concentration of 11.5%, a heating time of 10 minutes at a temperature of 18 (unheated), 120, 180, 280 and 350° C.;

FIG. 1B shows the measurement by infrared spectroscopy of the incorporation of indigo in the sepiolite tunnels, for an indigo concentration of 11.5%, a heating time of 10 minutes at a temperature of 18 (unheated), 120, 180, 280 and 350° C.;

FIG. 1C shows the influence of the temperature of production of the composite based on complexes on the incorporation of indigo in the sepiolite tunnels, for a total indigo concentration of 23% and heating temperatures of 25, 180, 280 and 320 and 350° C. for 20 minutes;

FIG. 1D shows, in a table, the percentage of indigo incorporated in the sepiolite tunnels with respect to the indigo remaining outside, as a function of the temperature of production of the composite based on complexes, for a total indigo concentration of 23% and heating temperatures of 25, 180, 280 and 320 and 350° C. for 20 minutes;

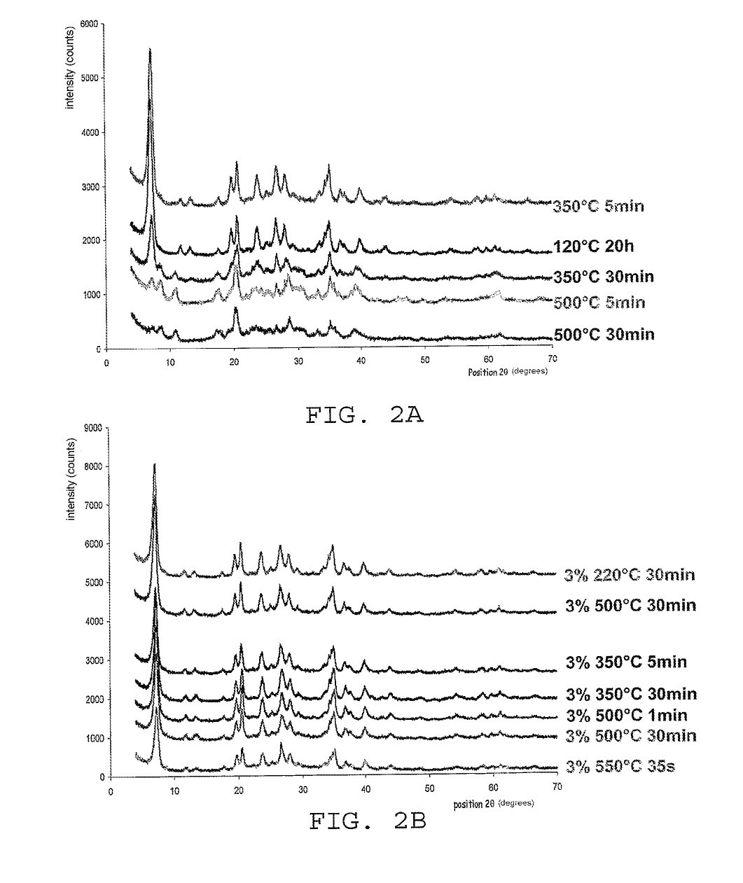

FIG. 2A shows the measurement by X-ray diffraction of the partial breakdown after heating at 350° C. for 30 minutes and total breakdown after heating at 500° C. of the sepiolite structure in the absence of indigo;

FIG. 2B shows the measurement by X-ray diffraction of the preservation of the intact sepiolite structure in the presence of indigo after heating at between 350 and 500° C.;

FIG. 2C shows the measurement by infrared spectroscopy of the partial breakdown after heating at 350° C. for 30 minutes of the sepiolite structure in the absence of indigo, and the preservation of the intact structure in the presence of indigo after heating at between 350 and 500° C.;

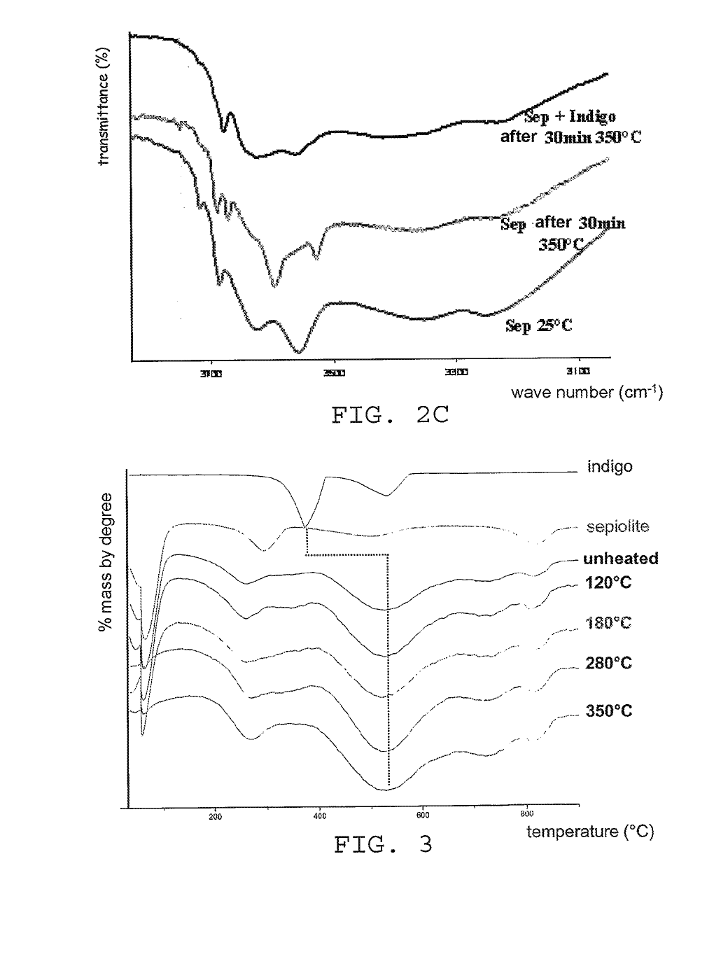

FIG. 3 shows the measurement by thermogravimetry of the shift in the temperature of decomposition of native indigo with respect to the indigo incorporated in the sepiolite tunnels after heating at 18 (unheated), 120, 180, 280 and 350° C. for 10 minutes, for an indigo concentration of 11.5%;

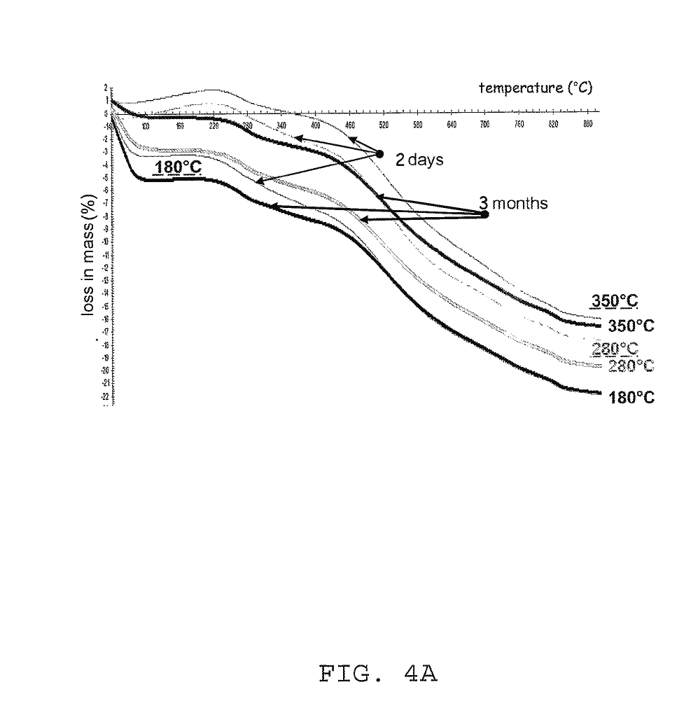

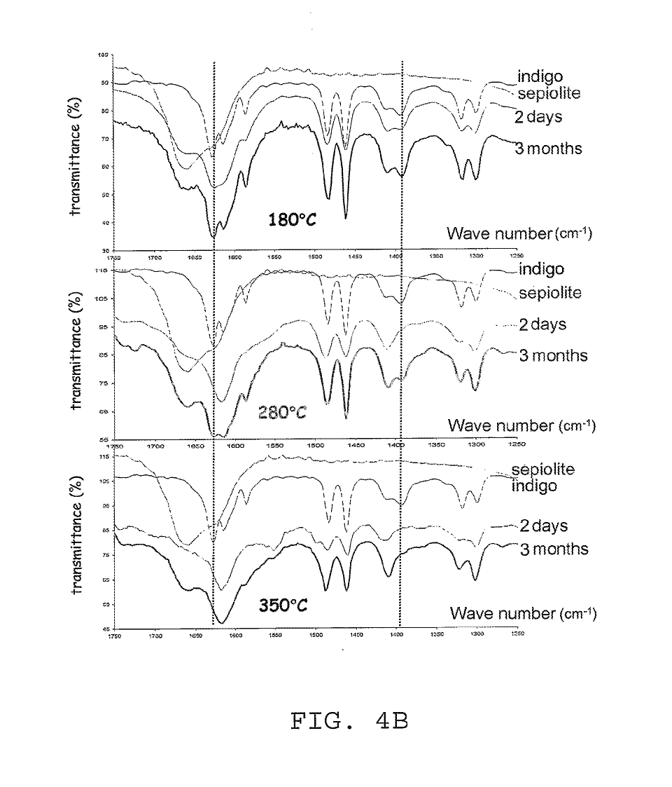

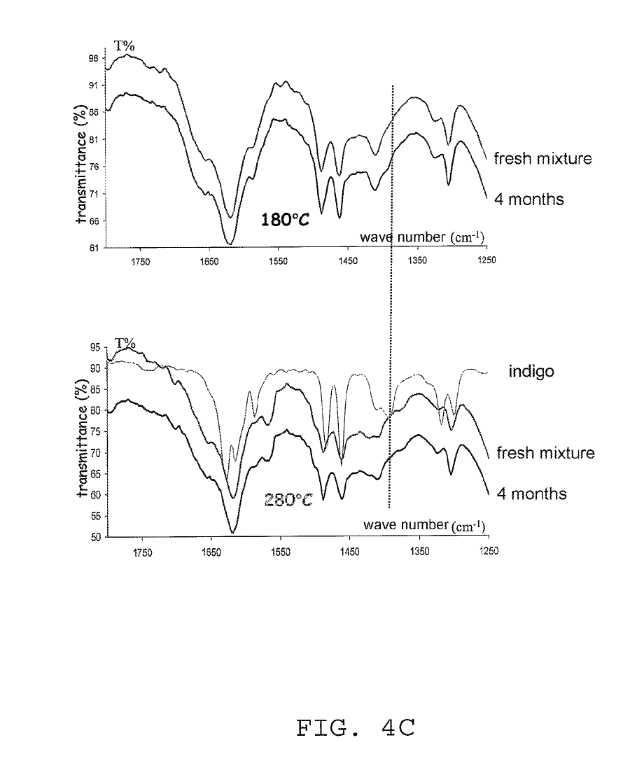

FIG. 4A shows the measurement by thermogravimetry of the stability of the incorporation of indigo in the sepiolite tunnels after 2 days and 3 months, for an indigo concentration of 11.5%, a heating time of 10 minutes at a temperature of 180, 280 and 350° C.;

FIG. 4B shows the measurement by infrared spectroscopy of the stability of the incorporation of indigo in the sepiolite tunnels after 2 days and 3 months, for an indigo concentration of 11.5%, a heating time of 10 minutes at a temperature of 180, 280 and 350° C.;

FIG. 4C shows the measurement by infrared spectroscopy of the stability of the incorporation of indigo in the attapulgite tunnels after 4 months, for an indigo concentration of 2.9%, a heating time of 30 minutes at a temperature of 180 and 280° C.;

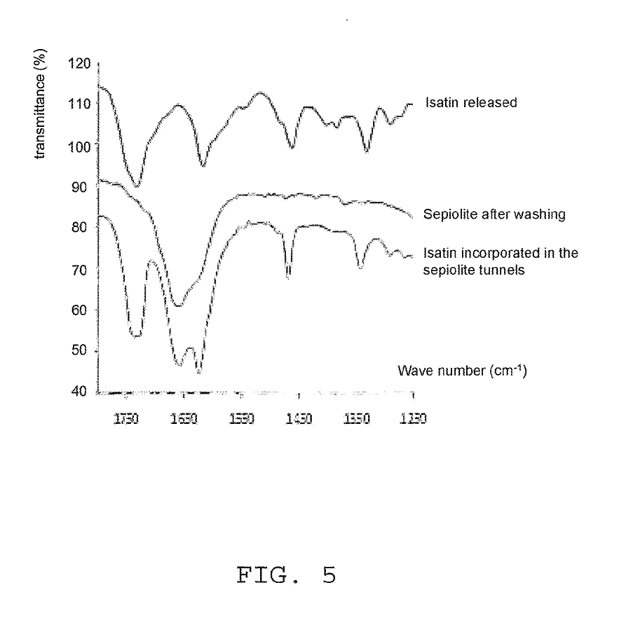

FIG. 5 shows the measurement by infrared spectroscopy of the release of isatin in the native state and the recovery of sepiolite in the native state after incorporation of isatin in the sepiolite tunnels in a stable manner in ambient air for 12 months, for an isatin concentration of 8%, a heating time of 10 minutes at a temperature of 220° C.;

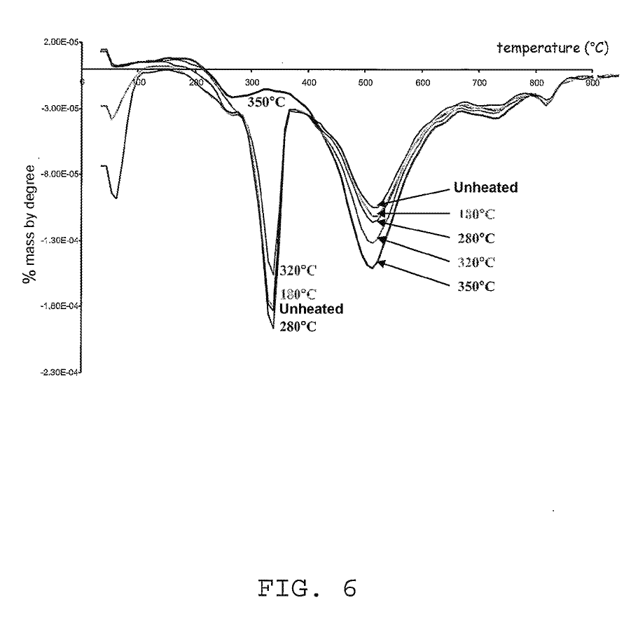

FIG. 6 shows the thermogravimetric behavior of 23% indigo/sepiolite mixtures after a step of cleaning by heating for 20 minutes at a temperature of 18 (unheated), 180, 280, 320 and 350° C.;

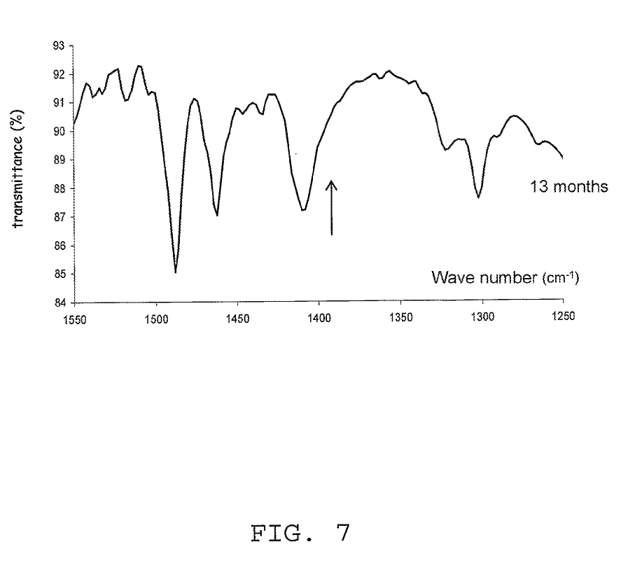

FIG. 7 shows the measurement by thermogravimetry of the stability of the incorporation of indigo in the sepiolite tunnels after 13 months, for an indigo concentration of 2.9%, a first heating time of 60 minutes at a temperature of 260° C., then a second heating, an annealing, for 40 minutes at a temperature of 300° C.

The method according to the invention relates to the production of a composite based on complexes of controlled stability over time, including, on the one hand, an inorganic fibrous matrix with tunnels, and, on the other hand, one or more organic compounds incorporated into said tunnels. It comprises the following steps, according to which: the inorganic fibrous matrix with tunnels and the organic compound(s) are provided;

the inorganic fibrous matrix with tunnels and the organic compound(s) are mixed so that said organic compound(s) are incorporated into the tunnels of the inorganic fibrous matrix; and

the stability of the composite based on complexes is controlled by heating said mixture obtained at a chosen temperature for a determined time.

In the text of this patent application, and unless otherwise specified, it is understood that, when a range of concentrations is defined, it includes the upper and lower limits of said range. Similarly, unless otherwise indicated, the proportions of the various constituents of the composition are expressed as a percentage by weight (w/w) of the total weight of said composite or said composition.

In addition, by composite based on complexes, we mean a material consisting of 2 or more phases of which the properties are better than those of the constituents taken independently. According to the invention, the composite includes a matrix that has at least one nanometric dimension in which charges or compounds are incorporated to form adaptive complexes.

By inorganic fibrous matrix with tunnels, we mean a matrix capable of incorporating, in its tunnels, one or more organic compound(s), of promoting their incorporation and of retaining them. Such matrices also have channels, with a structure similar to that of the tunnels, also capable of forming adaptive complexes with the organic molecules.

The inorganic fibrous matrices with tunnels used according to the invention are a clay or a zeolite.

By clay, we mean a sedimentary rock, comprised largely of specific minerals, such as silicates, in general of magnesium, more or less hydrated, that have a fibrous structure that explains its absorption qualities.

Preferably, the inorganic fibrous matrix with tunnels used according to the invention is a clay of the palygorskite family, and even more preferably a sepiolite or an attapulgite.

The organic compound(s) used according to the invention are a natural or synthetic dye molecule, a flavored gustatory or olfactory molecule, or an active molecule, taken alone or in combination.

According to the invention, the composite based on complexes includes between 0.05 and 30% organic compound by weight of the total weight of said composite, and preferably between 0.5 and 15%.

In particular, the organic compound(s) are in solid form, in particular in crystalline form when they are incorporated, or in liquid form.

Advantageously, the organic compound(s) used according to the invention are in pure form, i.e. used without solvent.

By synthetic or natural dye molecule, we mean any pigment or any dye.

By dye, we mean a colored substance, natural, artificial or synthetic, soluble or not in the associated suspension media, and which, unlike pigments, has only little to no opacity in the media in which it communicates a determined color.

Preferably, the synthetic or natural dye molecule is chosen from the indigoids, the anthraquinones, the flavonoids, the azoids, the melanins, the tetrapyrroles, the polymethines, the nitro dyes, the nitroso dyes, the diphenylmethane dyes, and the triphenylmethane dyes.

As non-limiting examples of indigoids, the following can be cited: indigo, dichloro-indigo, dibromo-indigo, thio-indigo, isatin, bromo-isatin, chloro-isatin, indirubin, and indigo acetates.

The following are obtained from indigoid molecules as composites based on complexes: blue, blue-green, yellow, green and violet dye compositions. The blue range, with tonalities ranging from light blue-green to dark blue, passing through the turquoise blues, is obtained from indigo. The yellow range, with tonalities ranging from yellow to brown, passing through the oranges, is obtained from isatin. The violet range, with tonalities ranging from pink to purple, is obtained from indirubin. The green range, with tonalities ranging from grass green to emerald green, is obtained from the indigo-isatin mixture.

As non-limiting examples of anthraquinones, purpurin, alizarin and carminic acid can be cited.

From anthraquinones, yellow, brown and red dye compositions are obtained as composites based on complexes. In open air, a range of yellow-brown pigments is obtained from dry alizarin. A purple, pink, orange range is obtained from purpurin. In both cases, in an acid medium (HCl water), the pigments are yellow-orange, in a basic medium (NaOH amine), they become blood-red. Shades of red are obtained by mixtures of alizarin and purpurin in a 20/80 ratio. Shades of orange are obtained from mixtures of alizarin and purpurin in an 80/20 ratio. In addition, these pigments are sensitive to the pH of the medium, which enables the color to be modulated.

As non-limiting examples of flavonoids, the following can be cited: anthocyanin, aurantinidin, cyanidin, rosidin, petunidin, benzoflavones, biflavonoids, catechin, chalcones, flavanones, flavones, flavonolignans, flavonols, isoflavones and proanthocyanidins.

Preferably, the flavored gustatory or olfactory molecule is chosen from the floral families, chypres, ferns, leathers, woods, orientals, hesperidins, musks, and spices.

The flavored series concerned are violet-iris, greenery, spice, rose, hesperidin, jasmine, orange tree, musk, tobacco, leather and wood.

In particular, the flavored gustatory or olfactory molecules are alcohols, esters, carbonyl derivatives, sulfur derivatives (mercaptans), nitrogen derivatives, and even more specifically terpenes, furanones, lactones, thiazoles, thiophenes, pyridines, pyrolines and pyranones. As non-limiting examples of terpenes, the following can be cited: ocimene, limonene, α-pinene, geraniol, menthol, menthone, terpineol, isoborneol, camphor, nerol, citronellal, citronellol, myrcene, myrcenol, linalol, irone, hedione, citral, phenylethylic acid, thymol, menthol, menthone, vanillin, camphor, anethol, eugenol, terpineol, dihydrojasmonate and coumarin.

By active molecule, we mean, for example, a biologically active molecule (drugs, vitamins, pesticides, insecticides) or electrically active molecule (conductive or insulating).

Preferably, the active molecule is chosen from the alcohols, esters, ethers, carbonyl derivatives, ketone derivatives, thiols, sulfur derivatives (mercaptans), nitrogen derivatives, phenols, polyphenols, alkaloids, carbohydrates, ureas, sulfonylureas, ethylenes, vitamins, amines, histamines, amino acids, acethylenes, acrylates, steroids and lipids.

As non-limiting examples of alkaloids, the following can be cited: the pyridines, pyrolidines, tropanes, quinolines, isoquinolines, phenylethylamines, indoles, purines, pyrazoles and cathecolamines.

As non-limiting examples of phenols, the following can be cited: salicylic acid, tyrosine, cannabinoids, serotonin, dopamine, adrenaline, noradecaline, levodopa and methyl salicycate.

As non-limiting examples of polyphenols, the following can be cited: tannins, flavonoids, including anthocyanins, flavanols, flavones, flavanonols, aurones, chrysin, quercetin, galangin and cathechin.

As non-limiting examples of nitrogen molecules, the following can be cited: purines, such as adenine, guanine, thymine, cytosine, uracil, xanthine, hypoxanthine, theobromine and caffeine.

As non-limiting examples of ureas, biureas, triureas, urethanes and derivatives thereof, and ureines can be cited.

As non-limiting examples of indoles, the following can be cited: ergine, serotonin, melatonin, psilocybin, dimethyltryptamine, 5-MeO-DMT or LSD, auxin, indometacin or pindolol.

As non-limiting examples of phenylethylamines, the following can be cited: amphetamine and derivatives thereof (methamphetamine, for example), mescaline and derivatives thereof (3,4-methylenedioxymethamphetamine, MDMA for example), adrenaline, tyramines, dimethyltryptamine and ephedrine.

As non-limiting examples of vitamins, the following can be cited: vitamin A, vitamin B1, vitamin B3, vitamin B5, vitamin B6, vitamin C and vitamin E.

As non-limiting examples of carbohydrates, the following can be cited: monosaccharides, dioses, trioses, pentoses, fructoses, glucoses and sucroses.

As non-limiting examples of biologically active molecules used as a drug, the following can preferably be cited: antibiotics such as pirazinamide, rifampicin, isoniazide, betalactamines, cephalosporins, fluoroquinolones, sulfamides, non-steroidal anti-inflammatories such assalicylic acid, sulindac, diclofenac, paracetamol, aceclofenac, ibuprofen, ketoprofen, naproxen, ketorolac, piroxicam, antioxidants such as vitamin A, vitamin C, vitamin E, cysteine, glutathione, glutamine and sulfur.

As non-limiting examples of electrically active molecules, the following can be cited: conductive organic polymers, in particular copolymers comprising at least ethylene, polyolefins or low-density polymers such as monomers, dimers or trimers derived, for example, from pyrrole, aniline, thiophene and melanin. Such molecules will preferably be introduced into the tunnels and channels of the inorganic matrix selectively, i.e. without external molecules and then polymerized in situ. The derivatives introduced will have, for example, alcohol or acid functions that will facilitate their incorporation and in particular their stabilization in the tunnels and channels of the matrix before polymerization.

The organic compounds are in particular limited by their size and their functional groups so as to enable their incorporation in the tunnels.

To be incorporated in the tunnels, two of the dimensions of the organic compound are less than or equal to 11 Å and 5.7 Å, and the third dimension is not limited. Advantageously, said organic compound is capable of conforming to such dimensions.

In particular, the organic compound(s) have one or more polar amine, amide, imine, nitrile, oxime, thiol, aldehyde, ketone, alcohol, phenol functions that facilitate their incorporation in the tunnels of the inorganic fibrous matrix by the formation of hydrogen bonds with the co-ordination water.

The presence of one or more phenyl groups in the organic compounds also promotes their incorporation in the tunnels of the inorganic fibrous matrix.

By mixture, we mean any type of mixture, preferably a mixture by grinding, manual or mechanical, of the inorganic fibrous matrix with tunnels and the organic compound(s) into a mortar until an intimate mixture is obtained so that the organic compound(s) are incorporated in the tunnels of the inorganic fibrous matrix.

The grinding time is between 0 and 72 hours, preferably between 1 minute and 1 hour. The grinding time is not proportional to the quantity of inorganic fibrous matrix with tunnels and the organic compound(s) mixed, but is determined on the basis of the amounts implemented so as to obtain an intimate mixture of such compounds with the matrix.

By control over time of the stability of the composite based on complexes, we mean the control of the reversibility of the incorporation of the organic compound(s) in the tunnels of the inorganic fibrous matrix. Thus, the maintenance of the organic compounds in the tunnels and the release thereof into the external medium, will be controlled, primarily by heating, during production of the composite, of the mixture obtained at a chosen temperature for a determined time.

Thus, the start of the zeolitic water from the inside of the tunnels of the inorganic matrix to the outside, as well as the start of the co-ordination water from the inside of the tunnels will be controlled by heating, during production of the composite, of the mixture obtained at a chosen temperature for a determined time so as to control over time the stability of the composite based on complexes.

By maintaining the organic compounds in the tunnels, we mean blocking the organic compounds in the tunnels for a number of months to a number of years, in a composite based on complexes that is thus stable, and even irreversible. The organic compounds will thus form bonds directly with the magnesium ions present on the walls inside the tunnels of the inorganic matrix. Such complexes thus formed will be stable, in particular in an anhydrous external medium. In an aqueous external medium or in ambient air over a longer term, the return of the co-ordination water is observed, as the composite remains stable.

By the release of organic compounds into the external medium, we mean the release into the external medium of organic compounds in their native form, while preserving their physicochemical properties, incorporated in the tunnels, as the hydrogen bonds between the organic compounds and the co-ordination water present in the tunnels is irreversible. The organic compounds form reversible bonds with the co-ordination water present inside the tunnels of the inorganic matrix, as the co-ordination water itself forms bonds with Mg ions.

The mixture is heated for between 0 and 120 hours, preferably between 1 minute and 1 hour, at a temperature of between 18 and 950° C.

According to the invention, the time and temperature of heating are chosen so as to control the stability of the composite obtained, i.e. the maintenance of organic compounds in the tunnels and their release into the external medium, for a given organic compound concentration, grinding time and external dispersion medium.

As an example, in the case of the production of a composite based on complexes including a sepiolite and 11.5% indigo, when the mixture is heated for 10 minutes at 120, 180 or 280 or even 350° C., the indigo is incorporated into the sepiolite tunnels.

Indeed, as shown in FIGS. 1A and 1B, in a composite based on complexes thus produced, the zeolitic water, i.e. one of the types of water located in the tunnels, is progressively replaced by indigo. This means that the indigo is incorporated into said tunnels. In addition, as shown in FIGS. 1C and 1D, the more the temperature of production (or heating) of the composite based on complexes is increased, the greater the concentration of incorporated indigo is, as the indigo concentration in the external medium decreases with the increase in the production temperature.

In FIG. 1A, according to the first portion of the curves, for curves relating to sepiolite alone and in an unheated 11.5% sepiolite/indigo mixture, the presence of 8% zeolitic water is observed in the sepiolite tunnels. It is noted that the percentage of zeolitic water present in the tunnels decreases from 5 to 3 to 1, then 0% when the mixture is heated for 10 minutes at temperatures of 120, 180, 280 and 350° C., respectively.

In FIG. 1B, according to the portion of the curves located at between 1650 and 1700 cm⁻¹, a band characteristic of the presence of zeolitic water is observed for the curve relating to sepiolite alone. A progressive disappearance is noted until the total disappearance of this band when the 11.5% sepiolite/indigo mixture is heated for 10 minutes at temperatures of 18 (unheated), 120, 180, 280 and 350° C., respectively. This also shows that the indigo is incorporated in the tunnels. In addition, the applicant showed, surprisingly, that the presence of an incorporated organic compound prevents the breakdown of a fibrous matrix. For example, the indigo incorporated in the sepiolite tunnels prevents the breakdown of same, while, in the presence of a zeolitic water alone, this breakdown begins at 200° C.

In FIGS. 1C and 1D, when the composite based on sepiolite/indigo complexes is heated and prepared at 25° C., only 12.6% of the 23% total indigo are incorporated in the sepiolite tunnels during thermogravimetric heating, with 10.4% remaining outside. The more the preparation heating temperature is increased, the greater the percentage of incorporated indigo is, namely 13.7% at 180° C., 14.1% at 280° C., 16.5% at 320° C. and 17.5% at 350° C. In addition, for heating temperatures of up to 320° C., the percentage of indigo not incorporated in the external medium is found, while at 350° C., indigo is no longer found in the external medium, as shown in table 1D. The 5.5% of indigo missing is not found in the external medium and has been broken down during the preparation of the composite at a heating temperature of 350° C.

As shown in FIGS. 2A, 2B and 2C, a partial breakdown in the structure of the sepiolite without indigo is observed after heating at 350° C. for 30 minutes, and the breakdown is complete after heating at 500° C. When indigo is present in the tunnels, the mixture can be heated at between 350 and 500° C., or even higher, as the complex formed preserves the same structure. It is observed that at up to 400° C., the indigo prevents the breakdown of the structure, and at beyond 400° C., carbon black is associated with the indigo, then replaces it at near 600° C. so as to prevent said breakdown.

In FIG. 2A, in the first portion of the graphs, for graphs relating to sepiolite alone heated for 20 hours at 120° C., i.e. 5 minutes at 350° C., an intensity peak characteristic of the native sepiolite structure is observed. It is noted that the intensity of this peak decreases when the sepiolite is heated for 30 minutes at 350° C., and this peak disappears when the sepiolite is heated for 5 or 30 minutes at 500° C. The disappearance of this peak is characteristic of the total breakdown of the sepiolite structure.

In FIG. 2B, for all of the graphs, it is observed that this intensity peak characteristic of the sepiolite structure in its normal and native state is maintained in the presence of indigo 3% in the mixture when it is heated for 30 minutes at 220° C., 5 minutes at 310° C., 5 or 30 minutes at 350° C., 1 or 30 minutes at 500° C. or even 35 seconds at 550° C.

In FIG. 2C, according to the portion of the curves located at between 3650 and 3700 cm⁻¹, for the curve relating to sepiolite alone heated at 25° C., a band corresponding to structural MgOH characteristic of the sepiolite structure in its normal and native state is observed. The presence of 2 bands in this same portion of the curve is noted when the sepiolite is heated for 30 minutes at 350° C. These 2 bands are characteristic of a breakdown of the sepiolite structure. It is also noted that, when indigo is present in the mixture, the band of structural MgOH characteristic of the sepiolite structure in its normal and native state is found when the mixture is heated for 30 minutes at 350° C.

In addition, as shown in FIG. 3, the maximum temperature of decomposition of indigo, which is around 375° C., increases to 540° C. when it is incorporated in the tunnels.

In FIG. 3, a peak characteristic of the decomposition of indigo is observed at a temperature of around 375° C. For the curves relating to an 11.5% sepiolite/indigo mixture, the disappearance of this peak is noted at around 375° C. This peak is offset to around 540° C. when the mixture has been heated at 18 (unheated), 120, 180, 280 and 350° C. during production of the composite.

Thus, there is a real synergy between the inorganic fibrous matrix and the organic compounds incorporated in the tunnels: the matrix protects the organic compounds from decomposition, and the organic compounds protect the matrix from breakdown of its structure.

However, for the same heating time of 10 minutes and for the same indigo concentration of 11.5%, the maintenance of indigo in the tunnels or its release into the external medium is dependent on and controlled over time by the control of the formation of different types of bonds between the organic compounds and the co-ordination water and the Mg ions present on the walls inside the inorganic matrix.

Indeed, as shown in FIG. 4A and FIG. 4B, when the mixture is heated at 350° C. during production, the indigo remains in the tunnels of the sepiolite after 3 months; therefore, the composite obtained, based on complexes, is stable, whereas, when the mixture is heated at 180 or 280° C., the composite based on complexes is reversible because the indigo is progressively released into the external medium, thus enabling water molecules to again penetrate the tunnels.

In FIG. 4A, according to the first portion of the curves, for the curve relating to the 11.5% sepiolite/indigo mixture heated for 10 minutes at 180° C., 3% zeolitic water is observed in the sepiolite tunnels after 2 days and 5% after 3 months: the indigo has therefore been released and replaced with zeolitic water. For the curve relating to the 11.5% sepiolite/indigo mixture heated for 10 minutes at 280° C., the absence of zeolitic water is observed in the tunnels after 2 days, and around 3% zeolitic water is incorporated in the tunnels after 3 months: the complex is therefore more stable than before. For the curve relating to the 11.5% sepiolite/indigo mixture heated for 10 minutes at 350° C., the absence of zeolitic water is noted both after 2 days and 3 months. The complex is therefore stable and tends to be irreversible.

Three distinct preparations are produced in which 0.13 g of indigo to 1 g of sepiolite are mixed in a mortar for 5 minutes for an 11.5% indigo concentration. The mixtures are then heated in an oven at 180, 280 and 350° C., respectively, for 10 minutes. FIG. 4B shows, according to the curves relating to indigo alone for each of the three conditions, namely baking at 180, 280 and 350° C., two peaks, characteristic respectively of the C═O groups at around 1625 cm⁻¹ as well as the NH groups at around 1390 cm⁻¹, of indigo. In addition, for the curves relating to the 11.5% sepiolite/indigo mixture heated for minutes, for heating at 180° C., these two bands are still present after 2 days and 3 months; for heating at 280° C., these two bands are no longer present 2 days after baking, but reappear 3 months after baking; and for heating at 350° C., these two bands disappear and do not reappear 2 days or 3 months after baking. In addition, the disappearance of these bands is characteristic of the incorporation of indigo in the sepiolite tunnels and the formation of a stable composite based on sepiolite/indigo complexes and tends to be irreversible. The reappearance of bands is proof of the reversibility of the system heated for 10 minutes at 180 and 280° C.

Two distinct preparations are produced in which 0.03 g of indigo to 1 g of attapulgite in a mortar for 5 minutes for a 2.9% indigo concentration. The mixtures are then heated in an oven at 180 and 280° C., respectively, for 30 minutes. FIG. 4C shows, according to the curves relating to indigo alone for each of the two conditions, namely baking at 180 and at 280° C., a peak characteristic of the NH groups of the indigo at around 1390 cm⁻¹. In addition, for the curves relating to the 2.9% attapulgite/indigo mixture heated for 30 minutes, for heating at 180° C., this peak disappears once the mixture is produced, but reappears 4 months after baking; and for heating at 280° C., this peak is no longer present 4 months after the baking. In addition, the disappearance of this peak is characteristic of the incorporation of indigo in the attapulgite tunnels and the formation of a stable composite based on attapulgite/indigo complexes and tends to be irreversible. The reappearance of bands is proof of the reversibility of the system heated for 30 minutes at 180° C.

Thus, according to the process conditions, after having chosen the inorganic fibrous matrix and the organic molecule concentration, for example, indigo, and mores specifically by controlling the temperature and the heating time, the maintenance in the tunnels and the release in the external medium of indigo, and more generally organic molecules according to the invention, is controlled. These organic compounds can thus be stabilized and immobilized over the long term, irreversibly, in the inorganic fibrous matrix.

It is noted that the heating is advantageously performed according to a plurality of sequential steps over time.

A first heating step is performed at a temperature above or equal to the temperature at the start of the zeolitic water of the tunnels of the matrix during a time so that most of said zeolitic water, contained in said tunnels, is removed, and so that the molecules forming the organic compounds can penetrate said tunnels and be distributed therein, relatively uniformly. It is noted however, that the temperature of this first heating step is advantageously lower, on the one hand, than the temperature at the start of the co-ordination water contained in the matrix and, on the other hand, than the temperature of destruction of the organic compounds. Indeed, if the temperature of this first heating step is greater than the temperature of decomposition of the molecules forming the organic compounds, then said compounds will be destroyed before penetrating the tunnels. It is noted that the removal of the zeolitic water is progressive, as is the penetration of the organic molecules over time. Obtaining a composite based on complexes, of which the organic molecules are correctly distributed in the tunnels, is important in view of the second heating step, which enables adequate control of the reversibility of the complexes and the composite.

This second heating step is performed at a temperature above the co-ordination water starting temperature. This start of the co-ordination water is progressive over time. As this co-ordination water starts, the organic molecules bind to the matrix in the tunnels at the level of the Mg ions. The higher the temperature is and the longer the heating time is, the less reversible the composite based on complexes is. Thus, the reversibility of the composite based on complexes is therefore finely controlled until a stable and irreversible composite is obtained, regardless of the external medium.

Such irreversibility can also be obtained by annealing of the complex obtained in the second step above. In this case, the annealing is performed at a temperature substantially greater than the co-ordination water starting temperature.

By heating at temperatures below 100° C., the release of the zeolitic water and the formation of bonds between the organic molecules incorporated in the tunnels of the inorganic fibrous matrix and the co-ordination water interacting with the Mg ions of the tunnels of the matrix are controlled. By heating at temperatures above 280° C., in particular at temperatures above 300° C., the release of the co-ordination water and the formation of bonds between the organic molecules and the Mg ions forming stable complexes in particular in an anhydrous external medium are controlled. Such bonds are, however, reversible in an aqueous external medium, in particular with the return of the co-ordination water, while the composite remains stable irreversibly after being passed by the formation of organic molecule-Mg complexes.

According to the method of the invention, the mixture can advantageously be heated at a temperature greater than or equal to the temperature of decomposition of the organic compound.

Indeed, as the temperature of decomposition of the organic compound increases due to its incorporation in the inorganic fibrous matrix, the mixture is heated, in particular at temperatures above 300° C., preferably at 320° C. or higher, so as to stabilize and maintain the organic compound in the tunnels.

This will be the case in the production of a composite based on complexes including, on the one hand, an inorganic fibrous matrix and, on the other hand, a synthetic or natural dye molecule, taken alone or in combination.

However, when controlling the release of the organic compound into the external medium, in particular during the release of an olfactory molecule or a biologically active molecule, taken alone or in combination, the mixture is heated at temperatures below the temperature of decomposition of the organic compound, and in particular at temperatures below 300° C., so as to enable the progressive release of these organic compounds.

In addition, as shown in FIG. 5, a curve characteristic of the incorporation of isatin at a concentration of 8% in the sepiolite tunnels and channels is observed after a heating time of 10 minutes at a temperature of 220° C. in a stable manner for 12 months in ambient air. After three steps of washing in water, in which the composite formed by the incorporation of isatin in the sepiolite tunnels and channels is agitated, then said composite is centrifuged, after evaporation of the water, the release of isatin in the native state as well as the recovery of the sepiolite in the native state, characterized by their respective curves, are observed. Thus, in the presence of water or alcohol in the external medium, the isatin molecules are slowly released.

This FIG. 5 shows, as an example, the release in the native state of a biologically active molecule such as isatin. Indeed, isatin is a compound known as a potential monoamine oxidase (MAO) inhibitor. It is effective as an antidepressant, as well as against stress, anxiety and epilepsy. Certain substituted molecules such as isatin-β-thiosemicarbazone are active against the viruses.

In addition, the time and temperature of heating are chosen so as to control the color of the pigments when natural or synthetic dye molecules are incorporated in the tunnels of the inorganic fibrous matrix.

Indeed, for an organic dye molecule, a color corresponds to a given concentration, temperature and heating time.

The mixing by grinding is also a factor in the control of the stability of the composite based on complexes; the longer the grinding time is, the slower the release of the organic compounds into the external medium is.

By external medium, we mean air, water or any solvent. The external medium is also a factor in the control over time of the stability of the composite based on complexes, as there is a competition between the organic compound/inorganic fibrous matrix interactions and the organic compound/external medium interactions.

As examples, it is possible to cite indigo, indirubin and anthraquinones, which do not have any affinity for the aqueous media, as these compounds preferably remain in the tunnels of the inorganic fibrous matrix; however, isatin and anthraquinones have a high affinity for alcoholic media, and these compounds partially or completely leave the tunnels.

Advantageously, the method for producing a composite based on complexes according to the invention also comprises a step of controlling the pH.

This step enables the color of the pigments and/or the dyes to be modulated, as well as an even wider range of colors to be obtained.

Thus, to maximize the amount of organic compounds incorporated in the sepiolite tunnels, the composite is produced from a highly concentrated mixture of organic compounds, for example indigo/sepiolite mixtures in a ratio of 20/100 or 30/100.

Advantageously, the method for producing a composite based on complexes according to the invention also comprises a step of cleaning the preparation by heating. This cleaning by heating is performed at a temperature above the temperature of decomposition of the organic compound and below the temperature of decomposition of this organic compound after incorporation in the tunnels. This cleaning by heating step decomposes the organic compounds present in the external medium and not incorporated before then in the tunnels, enabling the external medium of the organic compounds to be cleaned. This enables a dye composition to be obtained of which the color is characterized uniquely by the concentration of organic compound incorporated in the tunnels, and the temperature and the time of heating chosen for the first baking.

Indeed, as shown in FIG. 6, according to the portions of the curves located at around 340° C., the presence of indigo in the external medium is observed, whereas at around 520° C., the presence of indigo in the sepiolite tunnels is observed. In addition, during the step of cleaning by heating at temperatures of 18 (unheated), 180, 280 and 320° C. for 20 minutes, a peak characteristic of the presence of indigo in the external medium is observed, as these molecules begin to decompose at 280° C. with a maximum rate at 340° C. This phenomenon is possible owing to surface interactions between the indigo and the sepiolite, which reduce the temperature of decomposition of the indigo, which in a pure product begins at 300° C. with a maximum at 390° C. However, this peak disappears after the cleaning by heating at 350° C. for 20 minutes. This shows that the external molecules were decomposed during the cleaning of the preparation and are therefore no longer present in the external medium. Also, at 520° C., a peak characteristic of the presence of indigo in the sepiolite tunnels is observed. This cleaning by heating step in this type of preparation enables only the molecules present in the tunnels to be preserved.

According to another procedure of the method for producing the composite based on complexes according to the invention, after the first baking, which primarily determines the incorporation of the organic compounds in the tunnels of the inorganic fibrous matrix, and advantageously the color and the stability of the mixture, and, after cooling, the mixture is heated successively at one or more temperatures between 18 and 950° C. Preferably, one or more annealings are performed by heating at high temperature, i.e. at temperatures above the temperature chosen for the first baking, and more preferably at a temperature above the temperature of decomposition of the organic compound in the native state and below the temperature of decomposition of the organic compound incorporated in the tunnels. This annealing step provides and increases the stability of the composite by one or more annealings of several minutes. The duration of the baking in the annealing step is preferably shorter than that of the initial step of heating of the mixture.

Thus, the first baking is performed at a temperature below that of the subsequent annealing(s) and for a duration longer than that of the subsequent annealing(s). Advantageously, the duration of the first baking is long, from 20 minutes to around 1 hour, at a temperature below the temperature of decomposition of the organic compound in the native state, so as to enable said organic compound to be incorporated in the tunnels of the inorganic fibrous matrix. The duration of the subsequent successive annealing(s) is shorter, from 1 minute to several minutes, less than one hour, at a temperature above the temperature of decomposition of the organic compound in the native state and below the temperature of decomposition of the organic compound incorporated in the tunnels, so as to maintain the organic compound incorporated in the tunnels irreversibly.

For example, as shown in FIG. 7, a preparation is produced in which 0.725 g of indigo is mixed with 25 g of sepiolite in a mortar for 60 minutes for a concentration of 2.9% indigo. This mixture is then heated a first time in an oven at 260° C. for 60 minutes. After cooling at ambient temperature, the mixture is again heated, an anneal is performed, at 300° C. for 40 minutes. FIG. 7 shows the absence of the peak characteristic of the NH groups of indigo at around 1390 cm⁻¹. In addition, the disappearance of this peak is characteristic of the incorporation of indigo in the sepiolite tunnels and the formation of a composite based on sepiolite/indigo complexes that are stable and irreversible 13 months later.

According to another procedure of the method for producing the composite based on complexes of the invention, the release of organic compounds into the external dispersion medium is improved by ultrasonication of the fibers of the inorganic matrix before the incorporation of the organic compounds.

Preferably, the isolated fibers are subjected to ultrasonication, then centrifuged and dried before incorporating the organic compounds according to the production method of the invention.

According to a particular procedure of the method for producing the composite based on complexes according to the invention, an inorganic fibrous matrix, in particular sepiolite, is mixed by grinding, with organic molecules, in particular indigo or isatin or indirubin, in a mortar. The mixture is heated for several minutes to several days at temperatures ranging from 400 to 700° C. so as to obtain decomposition polymers or carbon black, and non-native, incorporated stably and even irreversibly in the tunnels. The decomposition of the carbon blacks thus enables a panel of black to brown colors to be obtained.

According to a preferred embodiment of the production of the composite based on complexes according to the invention, an inorganic fibrous matrix is mixed with a combination of dye and olfactory molecules, dye and biologically active molecules, olfactory and biologically active molecules, or dye, olfactory and biologically active molecules. The molecules of a different type are introduced from their mixture or one after another. In the second case, molecule 2 is then introduced into the composite containing molecule 1 with process conditions that may be different from those used for molecule 1.

According to the invention, the control of the maintenance of organic compounds in the tunnels of an inorganic fibrous matrix and the release of dye, olfactory or biologically active molecules in various media enable new composite materials with controllable properties to be obtained.

The composite of controlled stability including, on the one hand, an inorganic fibrous matrix with tunnels and, on the other hand, one or more organic compounds incorporated into said tunnels, prepared according to the invention, is used in a preparation intended for use in cosmetics, pharmacology, nutritional therapy, agrofood, phytosanitation, petroleum, electronics or in paints.

By cosmetic use, we mean in particular a preparation intended for make-up and/or care product chemistry, hair coloring or a perfume or odorizing composition.

As examples of productions intended for make-up and/or care product chemistry, in particular to be applied on skin, lips and/or skin appendages, the following can be cited: lipsticks, lip balms, lip liners, liquid or solid foundations, in particular in a stick or a cup, concealers and skin coloring products, temporary tattoos, and eye make-up such as eye liners, in particular in the form of pencils, mascaras or eye shadows.

A person skilled in the art will be careful to select formulations including the composite according to the invention on the basis of the galenic form desired and so that the advantageous properties of the composite according to the invention are respected.

According to an alternative of the invention, a preparation according to the invention can also be used in the tobacco industry. Aromatic compounds are incorporated in the inorganic fibrous matrix added to the tobacco in cigarettes. The aromatic molecules are released during combustion, by the increase in temperature.

Complexes according to the invention can also be used to chelate cigarette tar so as to reduce the risk of cancer or the risk of rheumatoid arthritis recently attributed to cigarette tar.

By pharmacological use, we mean in particular a preparation administered orally or topically and intended to release the organic compound(s) in the human body.

Indeed, as an example according to the invention, a clay-antibiotic-lectin complex can be produced, to be absorbed orally in the context of the treatment of an infectious systemic disease so as to improve the bioavailability of the antibiotic and to reduce the adverse effects thereof. By controlling their maintenance in the tunnels of the fibrous clay, the antibiotics will be capable of resisting their passage into the gastric lumen, which is highly acidic on fasting, and to provide resistance to their interaction with the alimentary bolus during digestion. The maintenance of antibiotics in the clay tunnels also enables co-administration with other drugs of the treatment, themselves placed in comparable clay complexes.

Owing to the glycosylated groups adsorbed at the surface of the clay fibers, and according to a tendency specific to clay, the complexes will adhere to the mucous lining. This effect, combined with the release of the antibiotic triggered or promoted by the neutral pH of the intestinal lumen, will enable more effective absorption of the antibiotic and thus increase the plasma bioavailability thereof.

The following can thus be provided as examples of clay-pirazinamide-lectin complexes for the treatment of tuberculosis, or with other antibiotics such as fluoroquinolones, beta-lactamines, and cephalosporins for the treatment of other infectious diseases.

Clay-non-steroidal anti-inflammatories can also be produced in a preparation to be absorbed orally for intracolic delivery for a preventive treatment of colon cancer, for example. Such a complex, owing to the control of the maintenance of the anti-inflammatory inside the tunnels of the clay composite in an acid medium, enables the active molecule, for example salicylic acid, to pass through the gastric lumen without injuring it so as to be released with the increase in the pH in the colon. Such a complex according to the invention enables transport in the digestive tract of a large amount of non-steroidal anti-inflammatory owing to the high specific capacity of the clay, and in particular sepiolite, tunnels. Such a complex provides gastroprotection and directs the release of the chosen anti-inflammatory directly toward the colon, its target organ, and optionally toward precancerous lesions.

Any anti-inflammatory or other cyotoxic agent can thus be used in such a complex according to the invention, as well as any antibiotic intended for the digestive tract.

It is also possible to produce complexes according to the invention by incorporating, in the tunnels of the inorganic fibrous matrix, an antioxidant compound such as tocopherols (vitamin E), or other antioxidant molecules such as vitamin A, vitamin C, glutathione (sulfur tripeptide), cysteine, glutamine, or sulfur for the prevention of radio-induced digestive, cutaneous and/or gynecological lesions due to anticancer radiation treatment. Such complexes can be used alone or in combination in the same preparation. Thus, such a complex according to the invention, which is stable at ambient temperature, in an air or liquid medium, with a pH below 8, will be produced. Such a complex will be applied topically on the skin, on the scalp or on a genital or rectal mucous membrane, for example, while preserving its stability conferred by a chosen and determined heating temperature and time. It can also be absorbed orally or digestively, in an amount sufficient protect the mucous lining of the digestive tract, in particular the large intestine and the distal small intestine. Thus, some of the major complications of radiation treatment can benefit from the invention, including cutaneous complications such as epidermitis, mucous membrane complications such as radiation mucositis, alopecia and abdominal irradiation, digestive disorders such as nausea, diarrhea, radiation ileitis, the consequences of pelvic irradiation, such as early proctitis, painful inflammatory reactions at the anus, gynecological problems such as dryness, itching, vaginal burning or dyspareunia. When they are applied or administered before a radiation treatment session, the complexes may provide partial protection from the “free radical storm” triggered by irradiation, by deactivating the chain of formation of free radicals by the intervention of antioxidants contained in the complexes. When they are applied after the hours or days following the radiation session, the complexes will play a repair role owing to the antioxidants that they transport, optionally in lower concentrations.

As examples of other possible uses of complexes according to the method of the invention, it is possible to cite the oral administration of an intestinal protectant based on clay locally delivering a prokinetic or laxative drug in order to accelerate intestinal transit, for example the incorporation of neostigmine delivered at a pH above 7, at the intestine in the context of Ogilvie syndrome (pseudoobstruction of the intestine in elderly patients).

It is also possible to cite a “fine” preparation administered in the form of a spray through the biopsy channel of a fibroscope for spraying or through a radiologically guided probe at the obstruction site.

In the case of drug or industrial (heavy metals) intoxication, or in the context of endotoxin shock, a complex according to the invention can be used for administration orally or by a probe of an intestinal protectant based on clay containing an “antitoxic” agent, for example N-acetyl-cysteine or an inactivator. This will lead to chelation of the toxic products by the clay fibers and an exchange with the drug substance contained in the clay complex.

As examples of other possible cutaneous applications according to the invention, it is possible to cite, in the context of scarring in at-risk subjects (elderly subjects, post-operative patients, malnourished subjects), an application of a protective dressing that is modelable and that hardens in dry air, delivering an active substance helping with scarring. The complexes according to the invention can thus be administered, for example, in the form of a galenic patch for the delivery of a drug substance, which is passive, modelable, adhesive, dry during the day and easily removed for grooming or washing. Such a formulation enables allergic reactions to latex or other synthetic adhesives to be avoided. Such complexes can also be administered in the form of an antiseptic protective patch containing a powerful antiseptic of the hexomedine, povidone (betadine) or antibiotic type, in the context of intensive care in patients receiving infusions, in the prevention of local infections and septicemia associated with the catheter.

In the context of a possible use in dental surgery, complexes according to the invention can be used in bone reconstruction for periodontitis with complexes co-administered with a coral support providing mineral and organic osteoinduction substances.

In the context of a possible use in surgery, it is possible to administer complexes incorporating anti-inflammatory or fibrinolytic substances for administration in powder form at the peritoneal cavity to prevent surgical scars.

It is also possible to administer complexes according to the invention in the form of a surgical adhesive, by incorporating an organic substrate and the catalyst thereof. When the preparation is wetted, polymerization is triggered in the paste, which is applied to the scarring site, in particular for applications in gynecological celioscopy in particular, for post-delivery uterine or ovarian repair.

It is also possible to use complexes according to the invention for diagnostic applications in chromoendoscopy. It is possible to envisage producing different complexes each including a different dye, commonly used for this application, such as Lugol, methylene blue, toluidine blue and cresyl violet. The complexes could be co-infused by endoscopy by means of a spray catheter. The dyes would be selectively fixed according to the type of lesion (dysplasia, cancerization) or cells (metaplasia) present, and thus help in the diagnosis of the disease of the digestive tract mucous membrane.

A preparation according to the invention can be used in animal health, by incorporating aromatic molecules in particular, to mask the taste of certain drugs, of which the active molecule can advantageously be incorporated and associated with the aromatic molecule in the tunnels of the inorganic fibrous matrix, taken jointly in the same preparation or successively.

A preparation according to the invention can also be integrated in implants, in particular silicone, in order to reinforce this material and improve the release of active molecules, which are difficult to control in silicone. It is also possible advantageously to integrate a preparation according to the invention in the silicone used for vaginal rings and hormone release, and optionally for other types of implants below the skin. It is also possible to use a preparation according to the invention as an organo-mineral osteoinductive implant for filling the sealing space of a bone prosthesis used in orthopedic reparative surgery. As an example of an implant, it is possible to cite a sepiolite-biphosphonate-hydroxyapatite complex, for example zoledronic acid or any other biphosphonate, cytokine or other osteogenic growth factor.

Owing to the method according to the invention, a complex is produced which will enable a large dose of biphosphonates to be provided in the tunnels of the fibrous matrix, as hydroxyapatite crystals are provided at the surface of this matrix. Such a complex enables a product filling the space of a fracture to be implanted, with a high tolerance due to the natural origin of the product and by comparison with composites using solvents and toxic hydrocarbons. Such a complex thus provides biphosphonate, in particular zoledrinic acid, with a sufficient concentration. This active molecule is then released progressively over time, promoting osteogenesis, with ossification using, progressively over time, the hydroxyapatite brought to the outside of the complex. The clay-biphosphonate-hydroxyapatite complex will enable the sealing off of the space necessarily left when sealing the osteoarticular prosthesis with bone cement (Polymethylmethacrylate, PMMA). As it dries, the complex applied in the form of a hydric or alcoholic gel reconstituted, then mixed with PMMA, will seal the sealing space, locally stimulate osteogenesis with the creation of bone tissue of which the mineral substrate will be enriched by the hydroxyapatite crystals provided by the complex implanted in the fracture zone and dissolve after several days or weeks.

By phytosanitary use, we mean in particular a preparation intended for incorporating pesticides in the tunnels of the inorganic fibrous matrix. Such a preparation enables controlled release of active molecules and pesticides in soils having very different characteristics in terms of pH and/or moisture and protection of the environment and the user. We also mean a preparation intended for removal of pollution from soils or water.

By nutritional therapy and agrofood use, we mean a preparation intended for incorporating nutrients, in particular vitamins and/or mineral salts, advantageously associated with aromatic compounds, or all sorts of food additives, flavorings and/or preservatives, which can be administered orally.

As a non-limiting example of nutrients, we can cite any nutraceutical isolated and/or purified based on foods, short-chain fatty acids such as butyric acid, sphingomyelin, conjugated linoleic acids, flavonoids such as quercetin and catechin, as well as any prebiotic.

Owing to the method according to the invention, the incorporation for example of butyric acid in the tunnels of a clay matrix, for example, sepiolite, and the stability of this complex in an acid medium enables butyric acid to pass through the gastric lumen, then the small intestine in order to arrive at the colon and treat infectious diseases of the intestine. As the release can be promoted at a neutral pH, the release of butyric acid will preferably be performed in the colon. Such a method enables large amounts of butyric acid to be supplied to its intestinal target and maintained over time.

Similarly, it is possible to incorporate different antioxidants in the tunnels of the clay matrix, and to co-administer, in the same preparation, the different clay-antioxidant complexes. After oral administration in the liquid phase, the complexes pass through the gastric lumen without being broken down owing to their stability at an acid pH and are delivered progressively with the increase in the pH, thereby enabling their higher concentration at the distal ileon and the colon, their target sites, which are the most common areas of digestive problems in chronic intestinal bowel diseases.

According to the invention, the co-administration of antioxidants enables a beneficial interaction in their mode of action. In particular, vitamin C enables vitamin E to be regenerated and prolongs its antioxidant effects at moderate doses.

According to another example of a use of the complexes according to the invention, the addition of composites based on complexes incorporating catechin in a tea mixture contained in bags will enable better availability of the catechin in the cup absorbed. The infusion time is shorter and offers a better flavor. The number of cups necessary to achieve a beneficial effect on one or more organic functions in terms of well-being and lower predisposition to diseases will also be smaller. Moreover, the addition of clay complexes complexed in a coffee mixture is an original solution for obtaining some of the beneficial effects of green tea for coffee drinkers. The catechin would be released during percolation or infusion of the coffee. The clay fibers would be retained by the filters or will remain in the grinds.

Another possible use of complexes according to the invention concerns hair growth. A clay-minoxidil complex preparation will be applied on the scalp, enabling better distribution of the product and a base for massaging the scalp with a shampooing effect.

It is also possible according to the invention to prepare sludges transporting various substrates, including organic substrates (antioxidants) and which can simulate the original sludges (Dead Sea, ocean, Vichy).

By petroleum use, we mean a preparation used in the petroleum refining process. According to an alternative of the invention, a molecule is incorporated in the tunnels of the inorganic fibrous matrix capable of catalyzing the destruction of an impure petroleum molecule adsorbed and incorporated in the tunnels. According to another alternative of the invention, the inorganic fibrous matrix incorporates compounds reacting inside the tunnels so as to confer increase stability on the clay layers of the earth in oil wells.

By electronic use, we mean a preparation used in electrical cables, in particular to improve the electrical and thermal insulation of the cables. The maintenance of active insulating molecules in the tunnels of the inorganic fibrous matrix confers an electrically insulating property capable of resisting extreme thermal conditions, in particular in the case of fires. According to an alternative of the invention, a preparation can also be used to detect short circuits in the cables. A short circuit causes an increase in temperature. This increase in temperature then leads to the release of a pigment that colors the cable at the location of the short circuit and enables it to be detected.

By use in paints, we mean in particular a preparation intended for industrial or artists' paints, or for the coloring of concrete, cement, lime plaster, wood, elastomers or plastic materials.

A preparation according to the invention can also be used in optics, or in winemaking.

Of course, the invention is not limited to the embodiments and examples presented above, and a person skilled in the art, by means of routine operations, may be led to produce other embodiments that have not been explicitly described, which are part of the broad scope of the invention.

1. A method for producing a composite based on complexes of controlled stability over time including, on the one hand, an inorganic fibrous matrix with tunnels, and, on the other hand, one or more organic compounds incorporated into said tunnels, comprising the following steps, in which:
the inorganic fibrous matrix with tunnels and the organic compound(s) are provided, the matrix including zeolitic water and co-ordination water;
the inorganic fibrous matrix with tunnels and the organic compound(s) are mixed so that said organic compound(s) are incorporated into the tunnels of the inorganic fibrous matrix; and
the maintenance of the organic compound(s) in said tunnels, and the release thereof, heating said mixture obtained at a chosen temperature for a determined time, is controlled, a first step of heating being achieved at a temperature above the zeolitic water starting temperature and a second step of heating, at a temperature above the co-ordination water starting temperature, the temperature of the first heating step being lower than the temperature of the second heating step.

2. The method according to claim 1, wherein in that the inorganic fibrous matrix and the organic compound(s) are mixed by grinding and the grinding time is between 0 and 72 hours, and preferably between 1 minute and 1 hour.

3. (canceled)

4. The method according to claim 1, wherein the mixture is heated for between 1 minute and 1 hour, at a temperature of between 18 and 500° C.

5. The method according to claim 4, wherein the maintenance of the organic compound(s) is controlled by heating the mixture for between 1 minute and 1 hour, at a temperature above 300° C.

6. The method according to claim 1, wherein the mixture is heated or annealed at a temperature above or equal to the temperature of decomposition of the organic compound.

7. (canceled)

8. The method according to claim 1, wherein the inorganic fibrous matrix with tunnels is a clay of the palygorskite family.

9. The method according to claim 8, wherein the clay is a sepiolite.

10. The method of claim 1, wherein the organic compound(s) are a natural or synthetic dye molecule, a flavored gustatory or olfactory molecule, or an active molecule, taken alone or in combination.

11. The method according to claim 10, wherein the organic compound(s) are synthetic or natural dye molecules chosen from the indigoids, the anthraquinones, the flavonoids, the azoids, the melanins, the tetrapyrroles, the nitro dyes, the nitroso dyes, the polymethine dyes, the diphenylmethane dyes, and the triphenylmethane dyes.

12. (canceled)

13. The method according to claim 10, wherein the active molecule is chosen from the alcohols, esters, ethers, carbonyl derivatives, ketone derivatives, thiols, sulfur derivatives (mercaptans), nitrogen derivatives, phenols, polyphenols, alkaloids, carbohydrates, ureas, sulfonylureas, ethylenes, vitamins, amines, amino acids, acethylenes, acrylates, steroids and lipids.

14. The method according to claim 1, wherein the composite based on complexes includes between 0.05 and 30% organic compound by weight of the total weight of said composite.

15-16. (canceled)

17. The method according to claim 1, further comprising at least one step of annealing the mixture of the inorganic fibrous matrix with tunnels and the organic compound(s) preferably performed after cooling of said mixture, after the initial heating step.

18-20. (canceled)

21. The method according to claim 1, further comprising an ultrasonication of the inorganic fibrous matrix.

22. The method according to claim 1, further comprising a step of controlling the pH.

23. (canceled)

24. The method according to claim 1, wherein the temperature of the first heating step is below the temperature of the co-ordination water starting temperature.

25. A method of manufacturing a cosmetic preparation, comprising incorporating a composite based on complexes of controlled stability developed according to the method of claim 1 in a preparation intended for a cosmetic use.

26. (canceled)

27. A method of manufacturing a pharmacological preparation, comprising incorporating a composite based on complexes of controlled stability developed according to the method of claim 1 in a preparation intended for pharmacological use.

28-29. (canceled)

30. A method of manufacturing a nutrition therapy and agrofood preparation, comprising incorporating a composite based on complexes of controlled stability developed according to the method of claim 1 in a preparation intended for use in nutrition therapy and agrofood.

31-32. (canceled)

33. A method of manufacturing a phytosanitary preparation, comprising incorporating a composite based on complexes of controlled stability developed according to the method of claim 1 and incorporating pesticides in a preparation intended for phytosanitary use.

34-37. (canceled)

38. A method of manufacturing an industrial or artists' paint or a concrete, cement, lime plaster, wood, elastomer, or plastic material coloring preparation, comprising incorporating a composite based on complexes of controlled stability developed according to the method of claim 1 in a preparation intended for industrial or artists' paints, or for coloring concrete, cement, lime plaster, wood, elastomers or plastic materials.

39. (canceled)
